(19) United States
(12) Patent Application Publication
(10) Pub. No.: US 2007/0127530 A1
(43) Pub. Date: Jun. 7, 2007

(54) Laser control

(75) Inventors: Qi Pan, Didcot (GB); Joseph Barnard, London (GB)

Correspondence Address: SUGHRUE MION, PLLC, 2100 PENNSYLVANIA AVENUE, N.W., SUITE 800, WASHINGTON, DC, 20037, US

(73) Assignee: BOOKHAM TECHNOLOGY, PLC.

(21) Appl. No.: 11/293,308

(22) Filed: Dec. 5, 2005

(51) Int. Cl. H01S 3/13; H01S 3/00

(52) U.S. Cl. 372/38.02; 372/38.01; 372/29.021

(57) ABSTRACT

A control system for operating a laser, including: a laser driver and a controller for providing the laser driver with a first electrical input indicative of a desired value for an output characteristic of the laser. The laser driver is arranged to control a second electrical input from the laser driver to the laser on the basis of the first electrical input with reference to a first electric reference. The controller is arranged to control the first electrical input on the basis of an electrical indicator of an actual value of the output characteristic of the laser with reference to a second electrical reference of greater reliability than the first electrical reference, so as to compensate for any variations of the first electrical reference.

### FIELD OF THE INVENTION

The present invention relates to a laser control method and system.

### BACKGROUND OF THE INVENTION

Laser diodes are widely used for optical communications. In order to utilise a laser diode to produce communications signals, it is driven with certain electrical signals. In particular, the laser diode is provided with biasing and modulation currents superimposed on each other. These currents can be generated by a laser diode driver system.

A known laser control system 100 is shown in FIG. 1. The control system comprises a laser diode driver 102, which is connected to a laser diode 104. The laser diode driver 102 has a power set voltage input 106 and a modulation set voltage input 108, which control the operation of the laser diode driver 102. A monitor photodiode 110 is also connected to the laser diode driver 102. Both the laser diode 104 and monitor photodiode are connected to a voltage supply 112. The laser diode driver provides driving signals to the laser diode 104 in dependence on the input voltages at 106 and 108, and on the signal from the photodiode 110. The modulation current is provided to the laser diode 104 via a capacitor 114, and the bias current is provided to the laser diode 104 via an inductor 116. The capacitor 114 has a low impedance to the high frequency modulation signals, but a high impedance to the low frequency bias signals, thereby preventing the bias current from entering the modulation output of the laser diode driver 102. The inductor 116 has a low impedance to the low frequency bias signals, but a high impedance to the high frequency modulation signals, thereby preventing the modulation current from being diverted into the bias output of the laser diode driver 102. The monitor photodiode 110 is arranged such that it can receive a portion of the optical output of the laser diode 104. In response to receiving an optical signal, the monitor photodiode 110 generates a current related to the amount of light received. The monitor photodiode can therefore produce a signal which is related to the optical power output of the laser diode 104.

The laser diode driver 102 is typically constructed in hardware on a single integrated circuit (IC). The use of a single integrated laser diode driver gives advantages in terms of speed, power dissipation, cost and physical size. The user of such a laser diode driver 102 provides the desired voltages to the inputs 106 and 108 in order to provide the laser with a suitable bias current and modulation current.

The operation of the laser control system 100 in FIG. 1 can be seen with reference to FIG. 2, which shows a control loop 200 for controlling a laser in a system such as that shown in FIG. 1. The control loop has as input the power set voltage input 106 and the modulation set voltage input 108 as shown in FIG. 1.

The power set voltage 106 is input to a hardware (“HW”) power controller 202, which is part of the laser diode driver 102, shown in FIG. 1. The HW power controller also has as input a feedback signal from the monitor photodiode 110, which, as stated above, is related to the output power of the laser diode. The HW power controller 202 determines the bias current to be provided to the laser diode 104 in response to the value of the power set voltage 106 and the monitor current from the monitor photodiode 110. The HW power controller 202 performs this determination with reference to a HW reference voltage 206, which is also generated by the laser diode driver 102 IC. The HW power controller uses the feedback from the monitor photodiode 110 to stabilise the output power of the laser diode 104.

The modulation set voltage 108 is applied to a HW modulation controller 204, which is part of the laser diode driver 102. The HW modulation controller 204 determines the modulation current to be applied to the laser diode 104. The modulation current applied to the laser diode 104 determines the extinction ratio of the laser diode, which is the ratio of the optical power levels when the laser is “on” and when it is “off”. The modulation set input 108 is referenced to the HW reference voltage 206 in the HW modulation controller 204 to determine the modulation current.

The outputs of the HW power controller 202 and HW modulation controller 204 are applied to a HW laser driver 208, which generates the bias current and modulation current to be provided to the laser diode 104.

### SUMMARY OF THE INVENTION

It has been observed that there can be a problem with this conventional approach. The control of both the bias current and the modulation current is dependent on the HW voltage reference 206, which is internal to the laser diode driver 102. Such voltage reference 206 can have a poor temperature coefficient, whereby the reference voltage drifts significantly over the range of operating temperatures. A change in the reference voltage would result in a change in the values of the bias current and modulation current, and therefore the average power and the extinction ratio

It is an aim of the present invention to provide a new type of laser control technique, which utilises the existing laser control hardware, but can compensate for variations in the reference voltage with a view to more accurately controlling one or more output characteristics of the laser such as, for example, the average laser power and/or extinction ratio.

According to a first aspect of the present invention, there is provided amethod of operating a laser using a laser driver, including the steps of: providing the laser driver with a first electrical input indicative of a desired value for an output characteristic of the laser; and controlling a second electrical input from the laser driver to the laser on the basis of said first electrical input with reference to a first electrical reference; and further including the step of: controlling the first electrical input on the basis of an electrical indicator of an actual value of said output characteristic of the laser with reference to a second electrical reference of greater reliability than the first electrical reference so as to compensate for any variation of the first electrical reference.

In one embodiment, the method includes the step of controlling said second electrical input from the laser driver to the laser on the basis of said first electrical input and an electrical indicator of an actual value of said output characteristic of the laser with reference to said first electrical reference.

In one embodiment, the output characteristic of the laser is the average output power or the extinction ratio.

In one embodiment, the step of controlling the first electrical input on the basis of an electrical indicator of an actual value of said output characteristic of the laser with reference to a second electrical reference is performed by a microprocessor.

In one embodiment, the step of controlling the first electrical input on the basis of an electrical indicator of an actual value of said output characteristic of the laser with reference to a second electrical reference includes reading a voltage indicative of an actual value of said output characteristic of the laser with an analogue to digital converter.

In one embodiment, the step of controlling the first electrical input on the basis of an electrical indicator of an actual value of said output characteristic of the laser with reference to a second electrical reference includes controlling a digital to analogue converter to provide the first electrical input to the laser driver.

In one embodiment, the step of controlling the first electrical input on the basis of an electrical indicator of an actual value of said output characteristic of the laser with reference to a second electrical reference includes reading a voltage reference with an analogue to digital converter.

According to a second aspect of the present invention, there is provided a control system for operating a laser, including: a laser driver; a controller for providing the laser driver with a first electrical input indicative of a desired value for an output characteristic of the laser;, wherein the laser driver is arranged to control a second electrical input from the laser driver to the laser on the basis of said first electrical input with reference to a first electric reference; and wherein the controller is arranged to control the first electrical input on the basis of an electrical indicator of an actual value of said output characteristic of the laser with reference to a second electrical reference of greater reliability than the first electrical reference so as to compensate for any variations of the first electrical reference.

In one embodiment, the control system further includes a monitor for producing an electrical indicator of an actual value of said output characteristic of the laser, and wherein the laser driver is arranged to control said second electrical input from the laser driver to the laser on the basis of said first electrical input and said electrical indicator of an actual value of said output characteristic of the laser with reference to said first electric reference.

In one embodiment, the monitor comprises a photodiode for receiving a portion of the optical output of the laser.

In one embodiment, the photodiode generates a photodiode current indicative of the average output power of the laser.

In one embodiment, a current indicative of the photodiode current passes through a photodiode current sensing resistor, whereby the voltage thereacross is indicative of the actual value of the average output power of the laser.

In one embodiment, the second electrical input comprises a laser bias current and a laser modulation current.

In one embodiment, the laser modulation current passes through a modulation current sensing resistor whereby the voltage thereacross is indicative of the laser modulation current.

In one embodiment, a current indicative of the laser bias current passes through a bias current sensing resistor whereby the voltage thereacross is indicative of the laser bias current.

In one embodiment, the controller is a microprocessor.

In one embodiment, the second electrical reference is read by the microprocessor using an analogue to digital converter.

In one embodiment, the first electrical input is provided to the laser driver by a digital to analogue converter controlled by the microprocessor.

In one embodiment, an electrical voltage indicative of an actual value of said output characteristic is read by the microprocessor using an analogue to digital converter.

In one embodiment, the first electric reference is generated by the laser driver.

In one embodiment, the second electrical reference is external to the laser driver.

According to a third aspect of the present invention, there is provided a controller for controlling a laser driver for operating a laser, wherein said controller is arranged to provide the laser driver with a first electrical input indicative of a desired value for an output characteristic of the laser; on the basis of which the laser driver controls a second electrical input from the laser driver to the laser with reference to a first electric reference; wherein the controller is arranged to control the first electrical input on the basis of an electrical indicator of an actual value of said output characteristic of the laser with reference to a second electrical reference of greater reliability than the first electrical reference so as to compensate for any variations of the first electrical reference.

According to another aspect of the present invention, there is provided a computer program product comprising program code means which when loaded into a computer controls the computer to carry out the steps of the above-described method of controlling the first electrical input on the basis of an electrical indicator of an actual value of said output characteristic of the laser with reference to a second electrical reference of greater reliability than the first electrical reference so as to compensate for any variation of the first electrical reference.

According to another aspect of the present invention, there is provided a method of modulating the output of a laser using a laser driver, including the steps of: providing the laser driver with a first electrical input indicative of a desired value for the extinction ratio of the modulated output of the laser; and controlling a second electrical input from the laser driver to the laser on the basis of said first electrical input; and further including the step of: also controlling the second electrical input on the basis of an electrical indicator of an actual value of the extinction ratio of the output of the laser.

In one embodiment, the step of controlling the second electrical input on the basis of an electrical indicator of the actual value of the extinction ratio of the output of the laser includes controlling the first electrical input on the basis of an electrical indicator of the actual value of the extinction ratio of the output of the laser.

According to another aspect of the present invention, there is provided a system for modulating the output of a laser using a laser driver, including a controller for providing the laser driver with a first electrical input indicative of a desired value for the extinction ratio of the modulated output of the laser, wherein the laser driver controls a second electrical input to the laser on the basis of said first electrical input; and wherein the controller is arranged to control the first electrical input to the laser on the basis of an electrical indicator of an actual value of the extinction ratio of the modulated output of the laser.

According to another aspect of the present invention, there is provided a controller for controlling a laser driver for modulating the output of a laser, wherein said controller is arranged to provide the laser driver with a first electrical input indicative of a desired value for the extinction ratio of the modulated output of the laser, on the basis of which the laser driver controls a second electrical input to the laser; and wherein the controller is arranged to control the first electrical input to the laser on the basis of an electrical indicator of an actual value of the extinction ratio of the modulated output of the laser.

### BRIEF DESCRIPTION OF THE DRAWINGS

For a better understanding of the present invention and to show how the same may be put into effect, reference will now be made, by way of example, to the following drawings in which:

FIG. 1 shows a known laser control system;

FIG. 2 shows a known control loop for controlling a laser;

FIG. 3 shows a laser control system according to an embodiment of the present invention; and

FIG. 4 shows a control loop for controlling a laser according to an embodiment of the present invention.

### DESCRIPTION OF PREFERRED EMBODIMENT

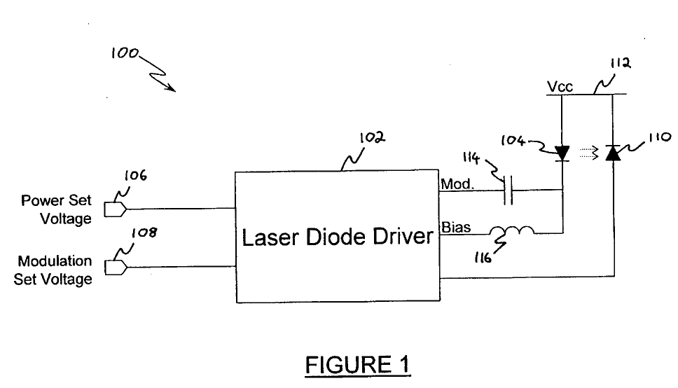

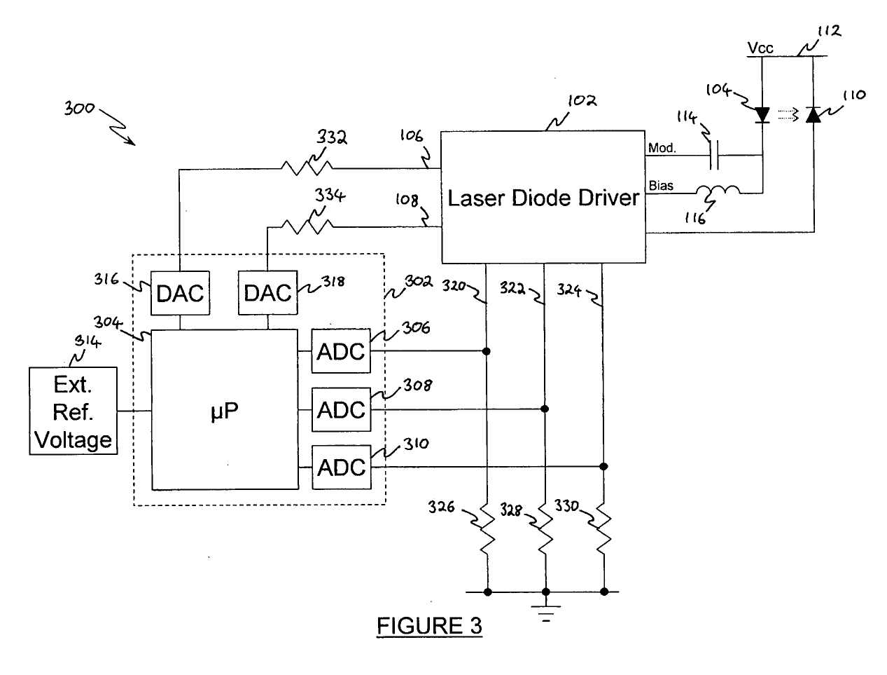

Reference will first be made to FIG. 3, in which is shown a laser control system 300 according to an embodiment of the present invention. The laser control system 300 comprises the same laser diode driver 102, as shown in FIG. 1, driving the laser diode 104 and receiving feedback from the monitor photodiode 110. As described previously, the laser diode driver 102 is controlled with a power set input 106 and a modulation set input 108.

The laser control system 300 in FIG. 3 also comprises a controller 302. The controller reads parameters of the laser diode operation and provides the inputs to the laser diode driver 102 in order to compensate for inaccuracies in the laser diode driver 102, such as the internal voltage reference.

The controller 302 comprises a microprocessor 304, which controls the operation of the controller 304. The controller also comprises several analogue to digital converters (ADC) (306, 308, 310) for providing measurements of input voltages to the microprocessor, and two digital to analogue converters (DAC) (316, 318) for providing outputs from the controller. The ADCs and DACs may be internal to the microprocessor 304 itself, but these are shown separately in FIG. 3.

The controller 302 uses three outputs from the laser diode driver. These are a bias monitor output 320, a power monitor output 322 and a modulation monitor output 324. These three outputs are connected to ground via three current sense resistors (326, 328, 330). The voltage across these resistors is read by the ADCs (306, 308, 310) of the controller 302.

The outputs of the controller DACs 316, 318 are applied to the power set input 106 and a modulation set input 108 of the laser diode driver 102 via resistors 332 and 334.

The laser control system 300 operates by measuring the outputs of the laser diode driver 102 and adjusting the inputs provided to the laser diode driver 102 in order to stabilise the output properties of the laser diode 104. In other words, the laser control system 300 adapts the target values for the bias and modulation control systems within the laser driver, in order to compensate for inaccuracies within the laser driver itself.

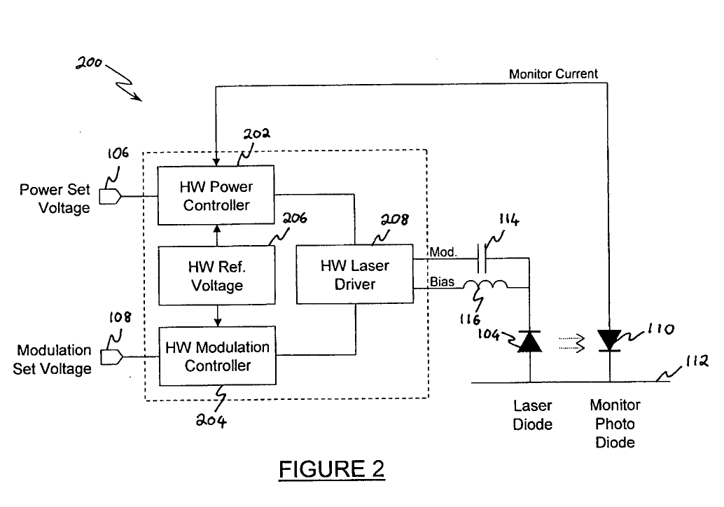

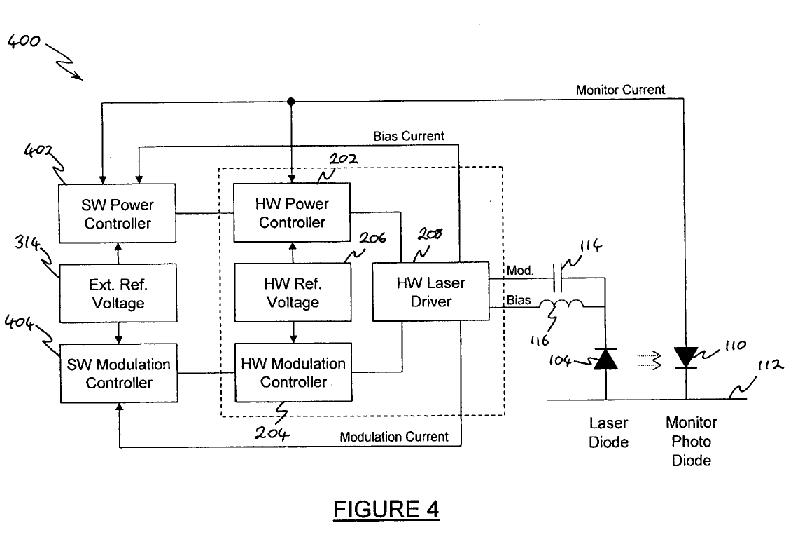

The detailed operation of the laser control system 300 can be seen with reference to the control loop 400 shown in FIG. 4. The control loop 400 has the same HW power controller 202, HW modulation controller 204, HW reference voltage 206 and HW laser driver 208 as described previously with reference to FIG. 2. The HW laser driver produces the electrical signals to drive the laser diode 104, and the monitor photodiode 110 provides feedback on the average output power of the laser diode 104.

The control loop 400 comprises a software (“SW”) power controller 402, which is implemented by the microprocessor 304 shown in FIG. 3. The SW power controller 402 performs a similar role to the HW power controller implemented on the laser diode driver 102. However, the SW power controller utilises an external voltage reference 314.

The external voltage reference 314 is connected to the microprocessor 304 as shown in FIG. 3. The external voltage reference 314 is a high quality voltage reference that has a stable temperature coefficient compared to the reference voltage 206 implemented in the laser diode driver 102. Therefore, the external voltage reference 314 is significantly more stable and accurate, and less prone to variation over the range of operating temperatures.

Hence, the microprocessor 304 has access to a stable voltage reference, which is used by the SW power controller 402 implemented on the microprocessor 304. The SW power controller 402 can therefore reliably control the laser diode power with relatively little susceptibility to changes in temperature.

In order to control the laser diode power, the SW power controller uses information fed back from the monitor photodiode 110, which indicates the average output power of the laser diode 104. In addition, the SW power controller 402 receives a feedback signal indicating the actual bias current provided to the laser.

Using a current mirror circuit, a current indicative of the bias current is provided to an output 320 of the laser diode driver 102, as shown in FIG. 3. This current from the output 320 is passed through a bias current sensing resistor 326, which produces a voltage across the resistor that is indicative of the bias current. The voltage across the bias current sensing resistor 326 is measured by the ADC 306 and read by the microprocessor 304. The microprocessor can calculate from this measurement the value of the bias current provided to the laser diode 104. Hence, the value of the actual bias current provided to the laser diode 104 can be utilised by the SW power controller 402.

Similarly, the laser diode driver 102 provides a current indicative of the monitor photodiode current via an output 322 to a photodiode current sensing resistor 328. The voltage across this resistor is measured using ADC 308, and hence read by the microprocessor 304.

The SW power controller 402 takes the inputs of the reference voltage 314, the bias current feedback and the monitor photodiode current feedback and generates an output control voltage. This output control voltage is converted from a digital to an analogue voltage level by the DAC 316, and provided to the input 106 of the laser diode driver 102 via resistor 332. Therefore, using the external voltage reference 314 and the feedback regarding the bias and photodiode currents, the SW power controller 402 produces an output power control voltage that is provided to the HW power controller 202. The value of this power control voltage is such that the laser average output power is maintained; even if the HW power controller 202 acts to change the bias current (e.g. due to a variation in temperature changing the reference voltage 206) the power control voltage compensates accordingly.

Therefore, the SW power controller 402 can accurately maintain the laser diode average output power by monitoring the bias current and the photodiode current in a microprocessor and adjusting the control voltage provided to the laser diode driver. The hardware control loop within the laser diode driver 102 is still used, but a second control loop is present around the hardware control loop to compensate for imperfections in the hardware control loop.

The control loop 400 also controls the modulation of the laser diode 104. The known laser control system shown in FIGS. 1 and 2 did not use any feedback control for the laser modulation. An absence of feedback control, combined with an unstable internal voltage reference can make the control accuracy of the extinction ratio inadequate. The control loop 400 adds feedback control to the modulation current, and also compensates for the unstable voltage reference 206.

The control of the modulation current is performed using a SW modulation controller 404 implemented in the microprocessor 304. The SW modulation controller 404 uses the high quality external voltage reference 314, the value of which is provided to the microprocessor 304 via the ADC 312. The SW modulation controller 404 also has as an input an indicator of the modulation current provided by the laser driver 102 to the laser diode 104. Using an internal current mirror, a current indicative of the modulation current is provided to an output 324 of the laser diode driver 102, as shown in FIG. 3. This current may typically be 1/100^{th} of the actual modulation current, and is passed through a modulation current sensing resistor 330, which produces a voltage across the resistor that is indicative of the modulation current. The voltage across the modulation current sensing resistor 330 is measured by the ADC 310 and read by the microprocessor 304. The microprocessor can calculate from this measurement the actual value of the modulation current provided to the laser diode 104 for use by the SW modulation controller 404.

Using the external voltage reference 314 and the indicator of the modulation current, the SW modulation controller 404 produces an output modulation control voltage that is provided to the HW modulation controller 204. The value of this modulation control voltage is such that the modulation current is maintained, such that even if the HW modulation controller 204 acts to change the modulation current (e.g. due to a variation in temperature changing the reference voltage 206) the modulation control voltage compensates accordingly. The output of the SW modulation controller 404 is output from the microprocessor 304 shown in FIG. 3 and converted to an analogue voltage level by the DAC 318, and is applied to the modulation set input 108 of the laser diode driver 102 via resistor 334.

By maintaining the value of the modulation current using the control loop the extinction ratio may be maintained. The control loop to maintain the extinction ratio is achievable since the laser working temperature is fixed by a thermoelectric cooler (TEC) controller (not shown).

The resistors used as current sensing resistors (326, 328, 330) are high stability resistors with a stable thermal coefficient, in order to ensure that their resistance value remains constant with temperature.

The control system described above can also be used to compensate for extinction ratio deterioration due to laser aging by mapping the laser bias current with the modulation current.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

What is claimed is:

1. A method of operating a laser using a laser driver, including the steps of: providing the laser driver with a first electrical input indicative of a desired value for an output characteristic of the laser; and controlling a second electrical input from the laser driver to the laser on the basis of said first electrical input with reference to a first electrical reference; and further including the step of: controlling the first electrical input on the basis of an electrical indicator of an actual value of said output characteristic of the laser with reference to a second electrical reference of greater reliability than the first electrical reference so as to compensate for any variation of the first electrical reference.

2. A method according to claim 1, including the step of controlling said second electrical input from the laser driver to the laser on the basis of said first electrical input and an electrical indicator of an actual value of said output characteristic of the laser with reference to said first electrical reference.

3. A method according to claim 1, wherein the output characteristic of the laser is the average output power or the extinction ratio.

4. A method according to claim 1, wherein the step of controlling the first electrical input on the basis of an electrical indicator of an actual value of said output characteristic of the laser with reference to a second electrical reference is performed by a microprocessor.

5. A method according to claim 4, wherein the step of controlling the first electrical input on the basis of an electrical indicator of an actual value of said output characteristic of the laser with reference to a second electrical reference includes reading a voltage indicative of an actual value of said output characteristic of the laser with an analogue to digital converter.

6. A method according to claim 4, wherein the step of controlling the first electrical input on the basis of an electrical indicator of an actual value of said output characteristic of the laser with reference to a second electrical reference includes controlling a digital to analogue converter to provide the first electrical input to the laser driver.

7. A method according to claim 4, wherein the step of controlling the first electrical input on the basis of an electrical indicator of an actual value of said output characteristic of the laser with reference to a second electrical reference includes reading a voltage reference with an analogue to digital converter.

8. A control system for operating a laser, including: a laser driver; a controller for providing the laser driver with a first electrical input indicative of a desired value for an output characteristic of the laser; wherein the laser driver is arranged to control a second electrical input from the laser driver to the laser on the basis of said first electrical input with reference to a first electric reference; and wherein the controller is arranged to control the first electrical input on the basis of an electrical indicator of an actual value of said output characteristic of the laser with reference to a second electrical reference of greater reliability than the first electrical reference so as to compensate for any variations of the first electrical reference.

9. A control system according to claim 8, further including a monitor for producing an electrical indicator of an actual value of said output characteristic of the laser, and wherein the laser driver is arranged to control said second electrical input from the laser driver to the laser on the basis of said first electrical input and said electrical indicator of an actual value of said output characteristic of the laser with reference to said first electric reference.

10. A control system according to claim 9, wherein the monitor comprises a photodiode for receiving a portion of the optical output of the laser.

11. A control system according to claim 10, wherein the photodiode generates a photodiode current indicative of the average output power of the laser.

12. A control system according to claim 11, wherein a current indicative of the photodiode current passes through a photodiode current sensing resistor, whereby the voltage thereacross is indicative of the actual value of the average output power of the laser.

13. A control system according to any of claims 8 to 12, wherein the second electrical input comprises a laser bias current and a laser modulation current.

14. A control system according to claim 13, wherein the laser modulation current passes through a modulation current sensing resistor whereby the voltage thereacross is indicative of the laser modulation current.

15. A control system according to claim 13, wherein a current indicative of the laser bias current passes through a bias current sensing resistor whereby the voltage thereacross is indicative of the laser bias current.

16. A control system according to claim 8, wherein the controller is a microprocessor.

17. A control system according to claim 16, wherein the second electrical reference is read by the microprocessor using an analogue to digital converter.

18. A control system according to claim 16, wherein the first electrical input is provided to the laser driver by a digital to analogue converter controlled by the microprocessor.

19. A control system according to claim 16, wherein an electrical voltage indicative of an actual value of said output characteristic is read by the microprocessor using an analogue to digital converter.

20. A control system according to claim 8, wherein the first electric reference is generated by the laser driver.

21. A control system according to claim 8, wherein the second electrical reference is external to the laser driver.

22. A controller for controlling a laser driver for operating a laser, wherein said controller is arranged to provide the laser driver with a first electrical input indicative of a desired value for an output characteristic of the laser; on the basis of which the laser driver controls a second electrical input from the laser driver to the laser with reference to a first electric reference; wherein the controller is arranged to control the first electrical input on the basis of an electrical indicator of an actual value of said output characteristic of the laser with reference to a second electrical reference of greater reliability than the first electrical reference so as to compensate for any variations of the first electrical reference.

23. A computer program product comprising program code means which when loaded into a computer controls the computer to carry out the steps of claim 1 of controlling the first electrical input on the basis of an electrical indicator of an actual value of said output characteristic of the laser with reference to a second electrical reference of greater reliability than the first electrical reference so as to compensate for any variation of the first electrical reference.

24. A method of modulating the output of a laser using a laser driver, including the steps of: providing the laser driver with a first electrical input indicative of a desired value for the extinction ratio of the modulated output of the laser; and controlling a second electrical input from the laser driver to the laser on the basis of said first electrical input; and further including the step of: also controlling the second electrical input on the basis of an electrical indicator of an actual value of the extinction ratio of the output of the laser.

25. A method according to claim 23, wherein the step of controlling the second electrical input on the basis of an electrical indicator of the actual value of the extinction ratio of the output of the laser includes controlling the first electrical input on the basis of an electrical indicator of the actual value of the extinction ratio of the output of the laser.

26. A system for modulating the output of a laser using a laser driver, including a controller for providing the laser driver with a first electrical input indicative of a desired value for the extinction ratio of the modulated output of the laser, wherein the laser driver controls a second electrical input to the laser on the basis of said first electrical input; and wherein the controller is arranged to control the first electrical input to the laser on the basis of an electrical indicator of an actual value of the extinction ratio of the modulated output of the laser.

27. A controller for controlling a laser driver for modulating the output of a laser, wherein said controller is arranged to provide the laser driver with a first electrical input indicative of a desired value for the extinction ratio of the modulated output of the laser, on the basis of which the laser driver controls a second electrical input to the laser; and wherein the controller is arranged to control the first electrical input to the laser on the basis of an electrical indicator of an actual value of the extinction ratio of the modulated output of the laser.
